(19) United States
(12) Patent Application Publication
(10) Pub. No.: US 2014/0090507 A1
(43) Pub. Date: Apr. 3, 2014

(54) ROBOT ARM AND ROBOT

(71) Applicant: KABUSHIKI KAISHA YASKAWA DENKI, Kitakyushu-shi (JP)

(72) Inventors: Kazutoshi IMAI, Fukuoka (JP); Nobuyuki FURUKAWA, Fukuoka (JP); Tadataka NOGUCHI, Fukuoka (JP)

(73) Assignee: KABUSHIKI KAISHA YASKAWA DENKI, Kitakyushu-shi (JP)

(21) Appl. No.: 14/035,953

(22) Filed: Sep. 25, 2013

(30) Foreign Application Priority Data
Sep. 28, 2012 (JP) 2012-218132

(51) Int. Cl. B25J 18/04

(52) U.S. Cl. CPC B25J 18/04
USPC 74/490.05

(57) ABSTRACT

A robot arm includes a first arm having a base end portion rotatably connected to an arm base, and a second arm having a base end portion rotatably connected to a tip end portion of the first arm and a tip end portion to which a robot hand is rotatably connected. Further, the robot arm includes a link unit having a base end portion rotatably supported with respect to the arm base and a tip end portion inserted into the first arm at an intermediate portion of the first arm and supported to make relative rotation with respect to the first arm. The link unit rotates the second arm with respect to the first arm by transmitting the relative rotation to the base end portion of the second arm.

### CROSS-REFERENCE TO RELATED APPLICATION

The present disclosure contains subject matter related to that disclosed in Japanese Priority Patent Application No. 2012-218132 filed on Sep. 28, 2012. The contents of this application are incorporated herein by reference in their entirety.

### BACKGROUND OF THE INVENTION

1. Field of the Invention

An embodiment disclosed herein relates to a robot arm and a robot.

2. Description of the Related Art

Conventionally, a horizontal articulated robot is known as a robot for transferring workpieces such as glass substrates and semiconductor wafers. The horizontal articulated robot is a robot including an extensible arm in which two arm portions are connected through a joint. In the horizontal articulated robot, an end effector provided in the tip end portion of the extensible arm is linearly moved by rotationally operating the respective arm portions. The horizontal articulated robot is configured such that a base unit supporting the extensible arm can rotate about a revolving axis as a vertical axis.

In the horizontal articulated robot, it is required that the orientation of the end effector attached to the tip end portion of the extensible arm is not changed by the rotating operation of the arm portions. In this regard, there has been proposed in, e.g., JP2005-66718A, an articulated robot in which the rotation of an end effector is restrained by a link mechanism operating in compliance with the rotating operation of individual arm portions.

More specifically, the articulated robot disclosed in JP2005-66718A restrains the rotation of the end effector through the use of a parallel link mechanism composed of a plurality of auxiliary links, at least one of which is pivoted to a joint interconnecting a base arm portion (a first arm) and a tip end arm portion (a second arm), in a coaxial relationship with the second arm.

Speed reducers are respectively provided at the base ends of the first and the second arm. The power of a motor as a drive power source is transmitted to the first arm and the second arm via the speed reducers and belt-pulley mechanisms, thereby rotating the first arm and the second arm.

### SUMMARY OF THE DISCLOSURE

In accordance with an aspect of the embodiment, there is provided a robot arm, including: a first arm having a base end portion rotatably connected to an arm base; a second arm having a base end portion rotatably connected to a tip end portion of the first arm and a tip end portion to which a robot hand is rotatably connected; and a link unit having a base end portion rotatably supported with respect to the arm base and a tip end portion inserted into the first arm at an intermediate portion of the first arm and supported to make relative rotation with respect to the first arm, the link unit rotating the second arm with respect to the first arm by transmitting the relative rotation to the base end portion of the second arm.

### BRIEF DESCRIPTION OF THE DRAWINGS

FIG. 1 is a schematic section view showing the configuration of a robot according to an embodiment.

FIG. 2A is a schematic plan view showing a robot arm in a most retracted state.

FIG. 2B is a schematic plan view showing the robot arm in an extended state.

FIG. 3A is a schematic section view showing the configuration of a robot which employs the same parallel link mechanism as in the related art.

FIG. 3B is a schematic plan view illustrating the minimum revolving radius of the robot which employs the same parallel link mechanism as in the related art.

FIG. 4 is a schematic section view showing the configuration of a robot which employs the same belt-pulley mechanism as in the related art.

### DESCRIPTION OF THE EMBODIMENTS

An embodiment of a robot arm and a robot disclosed in the subject application will now be described in detail with reference to the accompanying drawings. The present disclosure is not limited by the embodiment described herein below.

In the following description, there will be illustrated an example in which the robot is a transfer robot installed within a vacuum chamber and configured to transfer semiconductor wafers or glass substrates as objects to be transferred. The objects to be transferred will be referred to as “workpieces”. Moreover, the robot hand as an end effector will be referred to as “hand”.

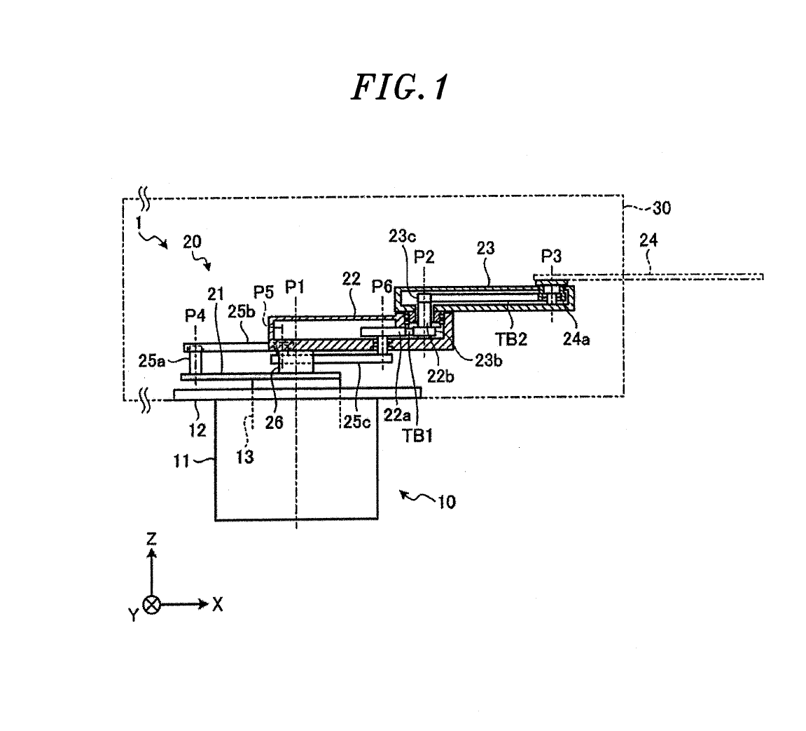

First, the configuration of a robot 1 according to the present embodiment will be described with reference to FIG. 1.

For the sake of easier understanding of description, a three-dimensional rectangular coordinate system including a Z-axis whose positive direction is a vertical upward direction and whose negative direction is a vertical downward direction is indicated in FIG. 1. The direction running along an XY plane designates a “horizontal direction”. The rectangular coordinate system will be sometimes indicated in other drawings used in the following description.

Referring to FIG. 1, the robot 1 is a horizontal articulated robot provided with an extensible arm which can be extended and retracted in the horizontal direction. More specifically, the robot 1 includes a body10 and a robot arm 20.

The body 10 is provided below the robot arm 20. The body 10 includes a housing 11, a flange 12 and a support 13.

The housing 11 is formed into a substantially tubular shape. Within the housing 11, there is provided a drive power source, e.g., a motor for rotating a first arm 22.

The flange 12 is formed in the upper portion of the housing 11. By fixing the flange 12 to a vacuum chamber 30, the robot arm 20 is installed within the vacuum chamber 30. A support rotation portion 26 supports a base end portion of the robot arm 20 (a base end portion of a first arm 22 to be described later). The support rotation portion 26 is rotated by the aforementioned drive power source and is configured to rotate the first arm 22 about an axis P1.

The robot arm 20 is connected to the body 10 through the support 13. More specifically, the robot arm 20 includes an arm base 21, a support rotation portion 26, a first arm 22, a second arm 23, a hand 24 and a link unit (to be described later).

The arm base 21 is a base of the robot arm 20 fixed to the upper surface of the support 13. The arm base 21 revolves above the flange 12 together with the rotation of the support 13. The base end portion of the first arm 22 is connected to the support rotation portion 26 so that the first arm 22 can rotate about the axis P1 with respect to the arm base 21.

The base end portion of the second arm 23 is connected to an upper portion of the tip end portion of the first arm 22 so that the second arm 23 can rotate about an axis P2. The base end portion of the hand 24 is connected to an upper portion of the tip end portion of the second arm 23 so that the hand 24 can rotate about an axis P3.

The robot arm 20 includes a post (support) 25a, a first link bar 25b and a second link bar 25c, which make up a link unit.

The post 25a is installed upright on the arm base 21. The base end portion of the first link bar 25b is pivoted to the post 25a so that the first link bar 25b can rotate about an axis P4.

The base end portion of the second link bar 25c is connected to the tip end portion of the first link bar 25b at the side lower than a lower surface of the first arm 22 and the first link bar 25b (at the side closer to the arm base 21) so that the second link bar 25c can rotate about an axis P5.

The tip end portion of the second link bar 25c is inserted into the first arm 22 from the lower surface of the first arm 22. In this regard, the tip end portion of the second link bar 25c is inserted into the first arm 22 in the intermediate portion between the base end portion and the tip end portion of the first arm 22.

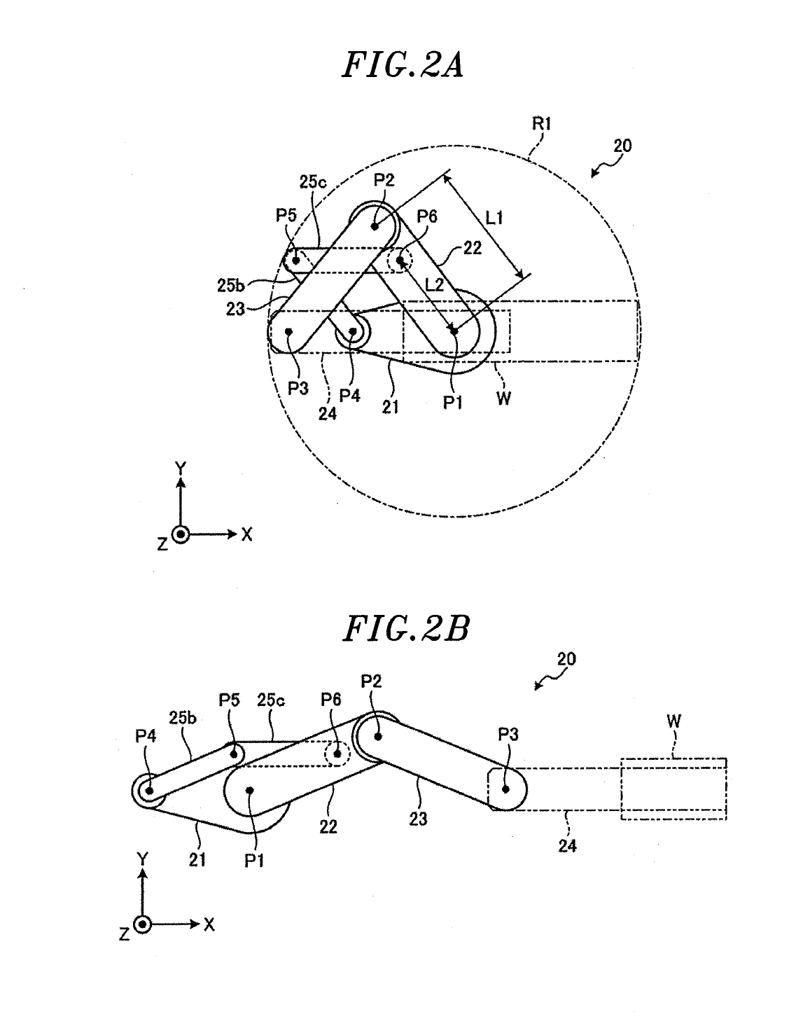

Preferably, the intermediate portion of the first arm 22 is positioned near the base end portion of the second arm 23. The content mentioned above will be described in more detail later with reference to FIG. 2A and other figures.

The tip end portion of the second link bar 25c inserted into the first arm 22 in the intermediate portion of the first arm 22 is rotatably supported about an axis P6 with respect to the first arm 22. The tip end portion of the second link bar 25c is provided with a fixed pulley 22a. Accordingly, if the first arm 22 rotates about the axis P1, the fixed pulley 22a makes relative rotation in response to the first arm 22.

In contrast, the tip end portion of the first arm 22 is provided with a fixed pulley 23b in the same height position as the fixed pulley 22a. The fixed pulley 23b is directly connected to the base end portion of the second arm 23 through a post 22b. The post 22b is installed upright within the tip end portion of the first arm 22 while extending through the central portion of the fixed pulley 23b.

The fixed pulley 23b and 22a are configured to have a predetermined pulley ratio and are interconnected by a timing belt TB1. Description on the predetermined pulley ratio will be made later with reference to FIG. 2A and other figures. Chloroprene rubber or the like can be appropriately used as a material of which the timing belt TB1 is made.

The fixed pulley 22a and the fixed pulley 23b may differ in thickness from each other. Accordingly, the fact that the fixed pulley 22a and the fixed pulley 23b are provided in the same height position means that the timing belt TB1 is arranged substantially parallel to the major surface of the first arm 22.

In this configuration, if the first arm 22 rotates about the axis P1, the fixed pulley 22a makes relative rotation in response thereto. The relative rotation of the fixed pulley 22a is transmitted to the fixed pulley 23b through the timing belt TB1, thereby rotating the second arm 23 about the axis P2 in the opposite direction with respect to the first arm 22.

A pulley 23c is fixed to the tip end portion of the post 22b. A pulley 24a is directly connected to the base end portion of the hand 24. The pulley 23c and the pulley 24a are interconnected through a timing belt TB2.

Accordingly, if the first arm 22 rotates about the axis P1, the pulley 23c makes relative rotation with respect to the second arm 23 in response thereto. The relative rotation of the pulley 23c is transmitted to the pulley 24a through the timing belt TB2, thereby rotating the hand 24 about the axis P3 in the opposite direction with respect to the second arm 23.

Next, the robot arm 20 seen in a plan view will be described with reference to FIGS. 2A and 2B.

The circle R1 indicated in FIG. 2A designates a trajectory described by the tip end portion of the second arm 23 or the base end portion of the hand 24 when the robot arm 20 rotates about the axis P1 in a most retracted state, which has a “minimum revolving radius”. The member designated by reference symbol W is a “workpiece”.

As shown in FIG. 2A, the link unit including the first link bar 25b and the second link bar 25c make up a so-called parallel link mechanism in between the arm base 21 and the first arm 22.

In the present embodiment, the length L2 between the axes P4 and P5 of the first link bar 25b or between the axes P5 and P6 of the second link bar 25c in the parallel link mechanism is set shorter than the length L1 between the axes P1 and P2 of the first arm 22.

More specifically, the interaxial length L2 of the first and the second link bar 25b and 25c (or the length of the first and the second link bar 25b and 25c), the resultant arrangement position of the base end portion of the first link bar 25b, and the resultant arrangement position of the tip end portion of the second link bar 25c (namely, the position of the intermediate portion of the first arm 22) are decided so that the parallel link mechanism can lie within the circle R1 when the robot arm 20 assumes a most-retracted minimum revolving posture.

At this time, it is preferred that the intermediate portion of the first arm 22 be positioned near the base end portion of the second arm 23. This makes it possible to shorten the length of the timing belt TB1 (see FIG. 1). It is therefore possible to restrain the power transmission rigidity from being reduced due to the timing belt TB1.

As shown in FIG. 2B, when extending the robot arm 20 from the minimum revolving posture, there is a need to restrict the movement direction and orientation of the hand to a predetermined direction and orientation (to an X-axis direction in FIG. 2B).

In the present embodiment, the movement direction and orientation of the hand 24 is restricted by the “predetermined pulley ratio” mentioned above. More specifically, the first arm 22 and the second arm 23 are rotated so that the rotation amount of the second arm 23 with respect to the first arm 22 can become twice as large as the rotation amount of the first arm 22 with respect to the arm base 21.

For example, if the first arm 22 is rotated by α degrees with respect to the arm base 21, the second arm 23 is rotated by 2α degrees with respect to the first arm 22. This can be realized by setting the pulley ratio of the fixed pulley 22a and the fixed pulley 23b to become “2:1”.

In the aforementioned case, it is desirable to rotate the hand 24 by α degrees with respect to the second arm 23. Accordingly, if the pulley ratio of the pulley 23c and the pulley 24a is set to become “1:2”, it is possible to rotate the hand 24 at the same rotation amount as the rotation amount of the first arm 22 and in the rotation direction opposite to the rotation direction of the second arm 23.

Accordingly, even when extending and retracting the robot arm 20, it is possible to restrict the movement direction and orientation of the hand 24 to a predetermined direction and orientation.

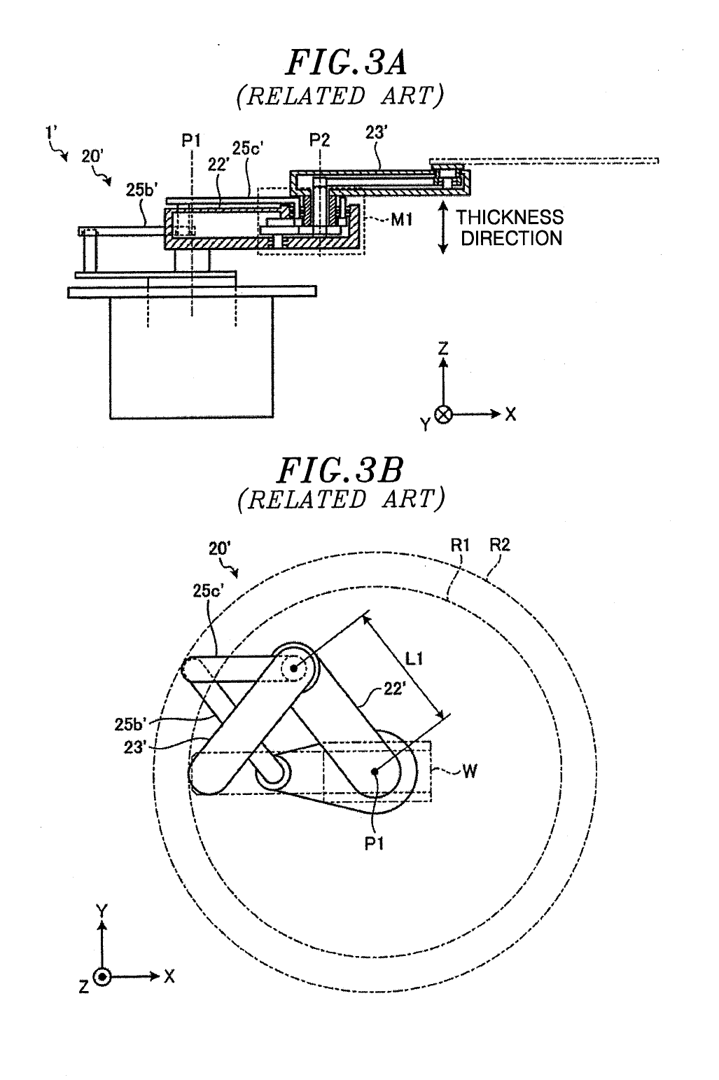

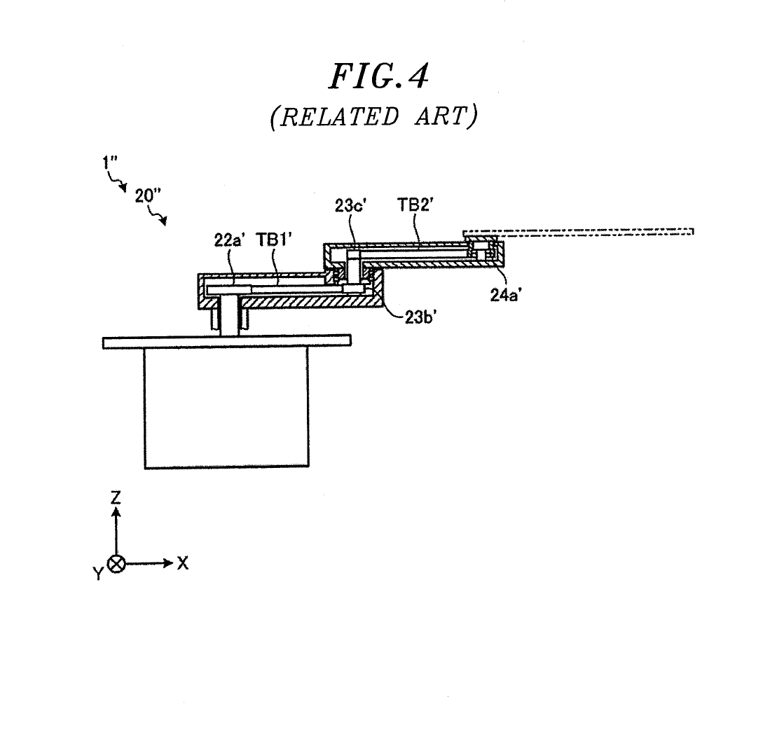

The effects achievable by the present embodiment set forth above will now be described with reference to FIGS. 3A, 3B and 4, which show the robots employing the conventional configuration.

FIG. 3A is a schematic section view showing the configuration of a robot 1′ which employs a conventional parallel link mechanism. FIG. 3B is a schematic plan view illustrating the minimum revolving radius of the robot 1′ which employs the conventional parallel link mechanism. FIG. 4 is a schematic section view showing the configuration of a robot 1″ which employs another conventional belt-pulley mechanism.

As for the robot 1′ and the robot 1″, description will be made on only the components to be compared with those of the robot 1 according to the present embodiment. Other components will not be shown and described.

As shown in FIG. 3A, the robot arm 20′ of the robot 1′ includes a first arm 22′, a second arm 23′ and a link unit composed of a first link bar 25b′ and a second link bar 25c′.

In the robot 1′, the second arm 23 is rotated by directly driving the gear train of a joint portion M1 with the second link bar 25c′ in response to the rotating operation of the first arm 22′. For that reason, there is a need to arrange the gears in two upper and lower stages, thereby increasing the speed. Thus, the first arm 22′ and hence the robot arm 20′ tend to become larger in thickness direction size.

Moreover, the second link bar 25c′ is connected at the side of the upper surface of the first arm 22′. This becomes a cause of increasing the thickness of the robot arm 20′ as a whole. It is therefore difficult to reduce the work space.

In the robot arm 20′ of the robot 1′, as shown in FIG. 3B, a parallel link mechanism is formed by making the interaxial length of the first link bar 25b′ or the second link bar 25c′ equal to the interaxial length L1 of the first arm 22′.

Therefore, the minimum revolving radius is larger than the radius of the circle R1 described by the tip end portion of the second arm 23′ and is equal to the radius of the circle R2 described by the elbow portion which is formed by the first link bar 25b′ and the second link bar 25c′. It is therefore difficult to reduce the work space.

As shown in FIG. 4, the robot arm 20″ of the robot 1″ includes pulleys 22a′, 23b′, 23c′ and 24a′ and timing belts TB1′ and TB2′. The robot arm 20″ employs a belt-pulley mechanism formed by merely combining the pulleys 22a′, 23b′, 23c′ and 24a′ and the timing belts TB1′ and TB2′.

In this case, the power transmission rigidity is significantly reduced due to the stretching, deflection and twisting of the timing belts TB1′ and TB2′. This may possibly become more difficult in linearly moving the workpiece W while maintaining the workpiece W in a predetermined orientation.

In this regard, with the robot 1 according to the present embodiment, the second arm 23 can be rotated by transferring the relative rotation in response to the rotation of the first arm 22 through the single-stage belt-pulley mechanism. This makes it possible to reduce the thickness of the robot arm 20. In other words, it becomes possible to reduce the work space.

Since the second link bar 25c is connected to the first arm 22 at the lower side of the first arm 22, it is possible to reduce the thickness of the robot arm 20. This makes it possible to narrow the work space.

Inasmuch as the interaxial length L2 of the first link bar 25b or the second link bar 25c is set shorter than the interaxial length L1 of the first arm 22, it is possible to reduce the minimum revolving radius. This makes it possible to narrow the work space.

Since the parallel link mechanism is employed in rotating the second arm 23, it is possible to secure the power transmission rigidity. In order to transmit the relative rotation of the first arm 22 to the second arm 23 through the second link bar 25c, the tip end portion of the second link bar 25c is arranged near the base end portion of the second arm 23. This makes it possible to use a short timing belt TB1. It is therefore possible to secure the power transmission rigidity through the use of the belt-pulley mechanism.

With the robot arm 20 according to the present embodiment and the robot 1 provided with the robot arm 20, it is possible to reduce the work space while securing of the power transmission rigidity.

Referring again to FIG. 1, in the robot 1 according to the present embodiment, the motor as a drive power source is accommodated within the housing 11 kept at the atmospheric pressure. The first arm 22 and the second arm 23 are accommodated within the vacuum chamber 30 kept under a depressurized environment.

In other words, the insides of the first and the second arm 22 and 23 are in vacuum state. Accordingly, it is possible to restrain the inside of the vacuum chamber 30 from being contaminated by particles generated due to the operation of the drive power source. In addition, it is possible to prevent trouble from occurring in the internal mechanisms of the first arm 22 and the second arm 23 under the influence of particles.

As described above, the robot arm according to the present embodiment includes the first arm, the second arm and the link unit. The base end portion of the first arm is rotatably connected to the arm base. The base end portion of the second arm is rotatably connected to the tip end portion of the first arm. The robot hand is rotatably connected to the tip end portion of the second arm. The base end portion of the link unit is rotatably supported with respect to the arm base. The link unit forms the parallel link mechanism in between the arm base and the first arm. The link unit rotates the second arm with respect to the first arm. The tip end portion of the link unit is inserted into the first arm in the intermediate portion of the first arm and is rotatably supported with respect to the first arm. The link unit transmits the relative rotation to the base end portion of the second arm, thereby rotating the second arm.

Accordingly, it is possible for the robot arm of the present embodiment to reduce the work space while securing the power transmission rigidity.

In the aforementioned embodiment, there has been described an example in which the robot is a transfer robot for transferring a workpiece. Alternatively, the robot may be a robot for performing a work other than the workpiece transferring work.

In the aforementioned embodiment, there has been described an example in which the robot is installed within the vacuum chamber. Alternatively, the robot may be installed in a chamber other than the vacuum chamber.

In the aforementioned embodiment, there has been described an example in which the timing belt is used as a member for interconnecting the pulleys. However, the present disclosure is not limited thereto. For example, a steel belt may be used in place of the timing belt. Moreover, the portion of the belt not making contact with the pulleys may be partially reinforced by a steel belt. A gear train may be used in place of the belt.

In the aforementioned embodiment, there has been described an example in which the robot has a single arm. However, the number of arms is not limited thereto. The present disclosure may be applied to a robot having two or more arms.

In the aforementioned embodiment, there has been described an example in which the object to be transferred is a wafer or a glass substrate. However, this is not intended to limit the kind of the object to be transferred.

It should be understood by those skilled in the art that various modifications, combinations, sub-combinations and alterations may occur depending on design requirements and other factors insofar as they are within the scope of the appended claims or the equivalents thereof.

What is claimed is:

1. A robot arm, comprising:
a first arm having a base end portion rotatably connected to an arm base;
a second arm having a base end portion rotatably connected to a tip end portion of the first arm and a tip end portion to which a robot hand is rotatably connected; and
a link unit having a base end portion rotatably supported with respect to the arm base and a tip end portion inserted into the first arm at an intermediate portion of the first arm and supported to make relative rotation with respect to the first arm, the link unit rotating the second arm with respect to the first arm by transmitting the relative rotation to the base end portion of the second arm.

2. The robot arm of claim 1, wherein fixed pulleys are respectively fixed to the tip end portion of the link unit and the base end portion of the second arm through a post, and wherein a belt for interconnecting the fixed pulleys is arranged to extend substantially parallel to a major surface of the first arm.

3. The robot arm of claim 1, wherein the tip end portion of the link unit is inserted into the first arm from a lower side of the first arm.

4. The robot arm of claim 2, wherein the tip end portion of the link unit is inserted into the first arm from a lower side of the first arm.

5. The robot arm of claim 1, wherein the link unit includes: a support installed upright on the arm base; a first link bar having a base end portion pivotally supported by the support; and a second link bar having a base end portion rotatably connected to a tip end portion of the first link bar at a position closer to the arm base than the first arm and the first link bar, and a tip end portion inserted into the first arm from a lower side of the first arm.

6. The robot arm of claim 2, wherein the link unit includes: a support installed upright on the arm base; a first link bar having a base end portion pivotally supported by the support; and a second link bar having a base end portion rotatably connected to a tip end portion of the first link bar at a position closer to the arm base than the first arm and the first link bar, and a tip end portion inserted into the first arm from a lower side of the first arm.

7. The robot arm of claim 3, wherein the link unit includes: a support installed upright on the arm base; a first link bar having a base end portion pivotally supported by the support; and a second link bar having a base end portion rotatably connected to a tip end portion of the first link bar at a position closer to the arm base than the first arm and the first link bar, and a tip end portion inserted into the first arm from the lower side of the first arm.

8. The robot arm of claim 4, wherein the link unit includes: a support installed upright on the arm base; a first link bar having a base end portion pivotally supported by the support; and a second link bar having a base end portion rotatably connected to a tip end portion of the first link bar at a position closer to the arm base than the first arm and the first link bar, and a tip end portion inserted into the first arm from the lower side of the first arm.

9. The robot arm of claim 1, wherein the intermediate portion of the first arm is positioned near the base end portion of the second arm.

10. The robot arm of claim 2, wherein the intermediate portion of the first arm is positioned near the base end portion of the second arm.

11. The robot arm of claim 5, wherein the length of the first link bar, the arrangement position of the base end portion of the first link bar, the length of the second link bar and the position of the intermediate portion of the first arm are decided such that, when a robot, to which the robot arm is installed, revolves about a revolving axis parallel to a vertical direction in a most retracted state of the robot arm, the link unit lies within a circle described by the tip end portion of the second arm or the base end portion of the robot hand.

12. The robot arm of claim 6, wherein the length of the first link bar, the arrangement position of the base end portion of the first link bar, the length of the second link bar and the position of the intermediate portion of the first arm are decided such that, when a robot, to which the robot arm is installed, revolves about a revolving axis parallel to a vertical direction in a most retracted state of the robot arm, the link unit lies within a circle described by the tip end portion of the second arm or the base end portion of the robot hand.

13. The robot arm of claim 7, wherein the length of the first link bar, the arrangement position of the base end portion of the first link bar, the length of the second link bar and the position of the intermediate portion of the first arm are decided such that, when a robot, to which the robot arm is installed, revolves about a revolving axis parallel to a vertical direction in a most retracted state of the robot arm, the link unit lies within a circle described by the tip end portion of the second arm or the base end portion of the robot hand.

14. The robot arm of claim 8, wherein the length of the first link bar, the arrangement position of the base end portion of the first link bar, the length of the second link bar and the position of the intermediate portion of the first arm are decided such that, when a robot, to which the robot arm is installed, revolves about a revolving axis parallel to a vertical direction in a most retracted state of the robot arm, the link unit lies within a circle described by the tip end portion of the second arm or the base end portion of the robot hand.

15. The robot arm of claim 2, wherein pulleys are respectively fixed to a tip end portion of the post and a base end portion of the robot hand; the post is inserted into the second arm and installed upright within the tip end portion of the first arm; and the orientation of the robot hand is restricted to a predetermined orientation as the pulleys fixed to the base end portion of the robot hand and the tip end portion of the post are interconnected by a belt.

16. The robot arm of claim 4, wherein pulleys are respectively fixed to a tip end portion of the post and a base end portion of the robot hand; the post is inserted into the second arm and installed upright within the tip end portion of the first arm; and the orientation of the robot hand is restricted to a predetermined orientation as the pulleys fixed to the base end portion of the robot hand and the tip end portion of the post are interconnected by a belt.

17. The robot arm of claim 6, wherein pulleys are respectively fixed to a tip end portion of the post and a base end portion of the robot hand; the post is inserted into the second arm and installed upright within the tip end portion of the first arm; and the orientation of the robot hand is restricted to a predetermined orientation as the pulleys fixed to the base end portion of the robot hand and the tip end portion of the post are interconnected by a belt.

18. The robot arm of claim 15, wherein the post extends through a central portion of the fixed pulley fixed to the base end portion of the second arm.

19. The robot arm of claim 1, wherein the inside of the first arm and the inside of the second arm are in vacuum state.

20. A robot provided with the robot arm of claim 1.
